(19) United States
(12) Patent Application Publication
(10) Pub. No.: US 2007/0053325 A1
(43) Pub. Date: Mar. 8, 2007

(54) Method and apparatus for securing wireless communications

(75) Inventors: Sung-Hyuk Shin, Northvale, NJ (US); Yogendra Shah, Exton, PA (US); Prabhakar R. Chitrapu, Blue Bell, PA (US); Alain Charles Louis Briancon, Poolesville, MD (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/409,668

(22) Filed: Apr. 24, 2006

Related U.S. Application Data
(60) Provisional application No. 60/674,842, filed on Apr. 26, 2005.

(51) Int. Cl. H04B 7/216

(52) U.S. Cl. 370/335

(57) ABSTRACT

A method and apparatus for securing wireless communications are disclosed. A watermark message is encoded to watermark message symbols. A cover message is encoded to cover message symbols. The watermark message symbols are then overlaid onto the cover message symbols to generate a watermark-embedded cover message in a physical layer. The watermark message symbols have a substantially lower amplitude than the cover message symbols. Thus, the watermark message introduces small perturbation around the constellation points of the cover message symbols. The watermark message symbol may span or spread over a plurality of cover message symbols and may be encrypted with a secret key. The watermark message is used for improving receiver performance by transmitting additional information or for security enhancement purposes. The watermarking function may be selectively turned on and off.

### CROSS REFERENCE TO RELATED APPLICATION

This application claims the benefit of U.S. Provisional Application Ser. No. 60/674,842 filed Apr. 26, 2005, which is incorporated by reference as if fully set forth.

### FIELD OF INVENTION

The present invention is related to securing wireless communications. More particularly, the present invention is related to a method and apparatus for securing wireless communications by overlaying a watermark onto a communication signal in a transport level.

### BACKGROUND

Wireless communication systems, by their very nature, are susceptible to security and privacy related attacks. The continuing growth in prevalence of these systems has further increased these vulnerabilities. Even ad-hoc networks, for instance, in which individual users communicate with each other directly without using intermediary network nodes, are susceptible to attacks on security, privacy, identity, or the like.

To reduce the inherent vulnerability of wireless communications, techniques such as Wired Equivalent Privacy (WEP), Wi-Fi Protected Access (WPA), Extensible Authentication Protocol (EAP), IEEE 802.11i, and Global System for Mobile Communication (GSM)-based encryption have been implemented in wireless communication systems. Although these techniques provide some protection, wireless communication systems still remain susceptible to attacks. For example, if a wireless user implements WEP security as a means of securing wireless communications, and the user receives a communication from an unknown network node possessing the correct WEP security keys, inclusion of correct WEP keys in the communication should alert the user that the communication is from a trusted source. However, since the user is not familiar with the sending node, and since WEP keys are just as likely to be hacked and copied as other wireless communications, the user may be reluctant to “trust” the communication. Even if a rogue user or hacker did not possess correct WEP security keys, since authentication of these keys typically occurs at higher layers of communication stacks, the rogue user or hacker could access the communication stack and, for example, implement a denial-of-service attack prior to the authentication.

A current technique for verifying and securing media content is known as watermarking. Watermarking, also known as “content watermarking”, is a technique for adding hidden verification and/or security data to various types of media content. Digital watermarking extends this concept to digital media. Content watermarking techniques, however, are designed to protect relatively static or unchanging types of content. Thus, for securing dynamic content, such as wireless communications transmitted in dynamic wireless environments, conventional content watermarking may not be suitable for protection.

Accordingly, it is desirable to have a method and apparatus for providing an enhanced watermarking scheme suitable for securing wireless communications signaling in dynamic wireless environments.

### SUMMARY

The present invention is related to a method and apparatus for securing wireless communications. A watermark message is encoded to watermark message symbols. A cover message is encoded to cover message symbols. The watermark message symbols are then overlaid onto the cover message symbols to generate a watermark-embedded cover message in a physical layer. The watermark message has a substantially lower amplitude than the cover message. Thus, the watermark message introduces small perturbation around the constellation points of the cover message symbols. The watermark message symbol may span or spread over a plurality of cover message symbols and may be encrypted with a secret key. The watermark message may be used for improving communication performance by transmitting additional information or for security enhancement purposes. The watermarking function may be selectively turned on and off.

### BRIEF DESCRIPTION OF THE DRAWINGS

FIG. 1 is a block diagram of a wireless communication system for encoding and decoding watermarks in accordance with the present invention.

FIG. 2 is a detailed block diagram of a watermark encoder in accordance with the present invention.

FIG. 3 is a graphical depiction of overlaying a watermark message to a cover message in accordance with the present invention.

FIG. 4A is a graphical depiction of a quadrature phase shift keying (QPSK) constellation before watermarking is performed.

FIG. 4B is a graphical depiction of a QPSK constellation after watermarking is performed in accordance with the present invention.

FIG. 5 graphically depicts a watermark-embedded cover signal in accordance with the present invention.

FIG. 6 graphically depicts a detection region for a given cover message symbol in accordance with the present invention.

FIGS. 7A-7C show constellation points of cover message symbols and a watermark embedded cover message symbol with a timing offset in accordance with the present invention.

### DETAILED DESCRIPTION OF THE PREFERRED EMBODIMENTS

When referred to, hereafter, the terminology “transmitter” and “receiver” include but are not limited to a wireless transmit/receive unit (WTRU), a user equipment (UE), a mobile station, a fixed or mobile subscriber unit, a pager, a Node-B, a base station, a site controller, an access point or any other type of device capable of operating in a wireless environment.

The features of the present invention may be incorporated into an integrated circuit (IC) or be configured in a circuit comprising a multitude of interconnecting components.

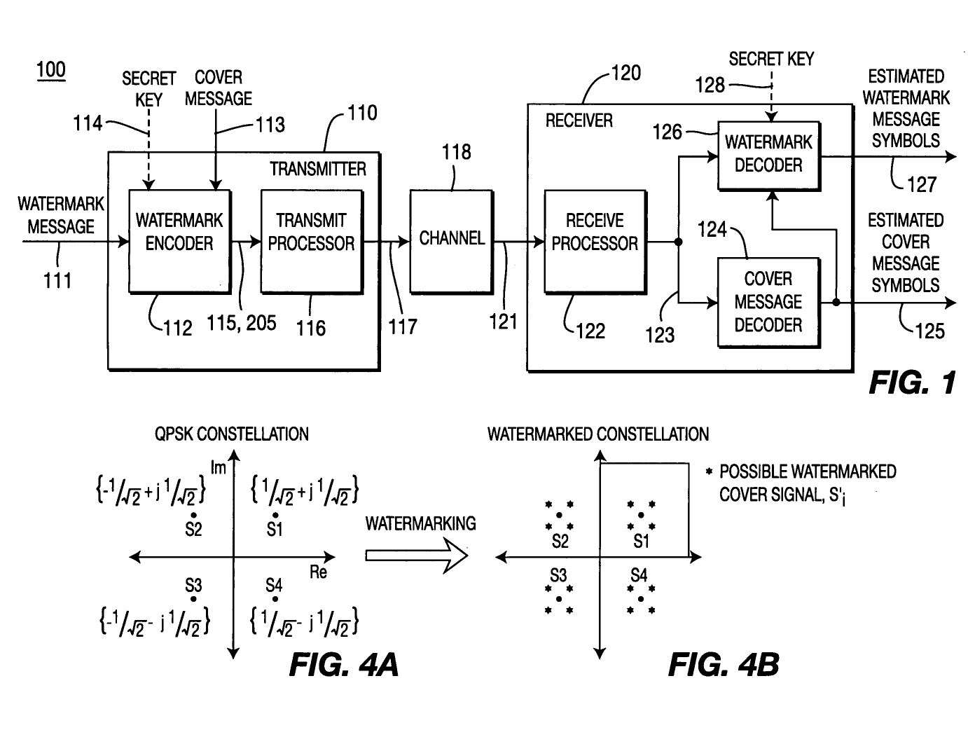

FIG. 1 is a block diagram of a wireless communication system 100 including a transmitter 110 for encoding watermarks and a receiver 120 for decoding watermarks in accordance with the present invention. The transmitter 110 includes a watermark encoder 112 and a transmit processor 116. The watermark encoder 112 receives a watermark message 111 and a cover message 113, and outputs a watermark-embedded cover message 115. The cover message 113 is data to be transmitted from the transmitter 110 to the receiver 120 over a channel 118 of an air interface. The watermark message 111 is data to be transmitted along with the cover message 113 so that the transmission of the watermark-embedded cover message 115 may be considered as a form of multiplexed communications.

The watermark message 111 may be used for security enhancement or communication performance improvement purposes, which will be explained hereinafter. The watermark message 111 may optionally be encrypted with a secret key 114 by the watermark encoder 112. The watermark-embedded cover message 115 is then processed by the transmit processor 116 and transmitted over the channel 118, during which time the transmitted signal 117 may be subject to attack.

In accordance with the present invention, the watermark message 111 is embedded in the cover message 113 in a physical layer. This physical layer processing may be added to a conventional wireless modem and introduced into a system without changing the conventional air interface specification. In accordance with the present invention, the watermarking functionality may co-exist with the conventional air interface and may be optionally turned on and off, by turning on or off the functionality inside the encoder 112, to selectively introduce secure links.

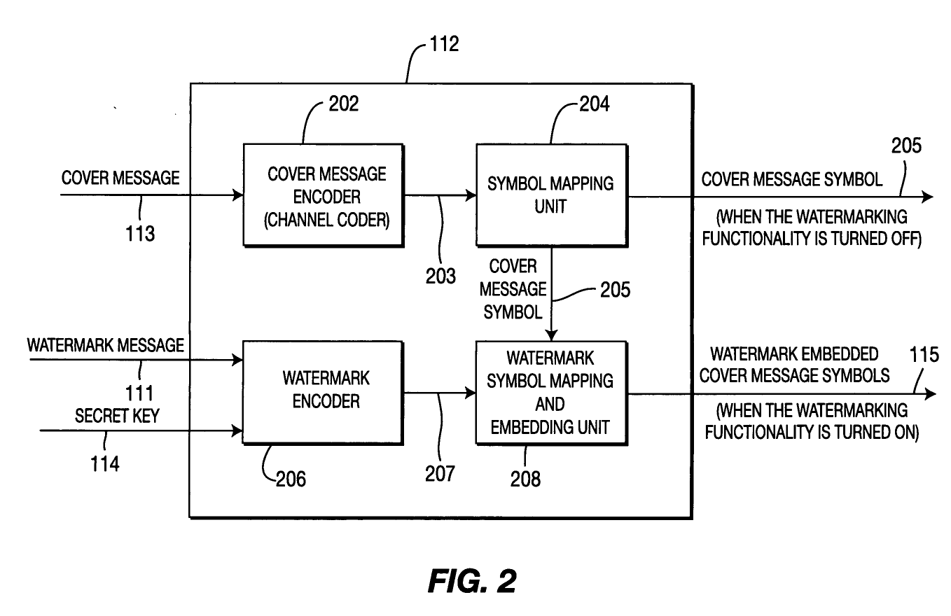

FIG. 2 is a detailed block diagram of a watermark encoder 112 in accordance with the present invention. The watermark encoder 112 includes a cover message encoder 202, a symbol mapping unit 204, a watermark encoder 206 and a watermark symbol mapping and embedding unit 208. The cover message 113 is encoded by the cover message encoder 202. The coded cover message 203 is then mapped to a cover message symbol 205 by the symbol mapping unit. The watermark message 111 is encoded, (optionally with a secret key 114), by the watermark encoder 206. The encoded watermark message 207 is mapped to one of the constellation points and overlaid onto the cover message symbol 205 by the watermark symbol mapping and embedding unit 208 to generate a watermark embedded cover message symbol 115.

The watermark symbol mapping and embedding unit may rotate the constellation of the encoded watermark message symbol by a fixed angle prior to embedding onto the cover message symbol.

When the watermark functionality is turned on, the watermark encoder 206 and the watermark symbol mapping and embedding unit 208 are enabled such that the watermark message 111 is encoded, (optionally using the secret key 114), and overlaid onto the cover message symbol 205 to generate the watermark-embedded cover message symbol 115. If the watermark functionality is turned off, the watermark encoder 206 and the watermark symbol mapping and embedding unit 208 are disabled and the watermark encoder 112 outputs the cover message symbol 205. Thus, the present invention maintains backward compatibility with a conventional system by firstly maintaining a low signal level (thus appearing as an additional source of a low level noise signal) for the watermark signal and secondly by being able to turn on or off the watermarking.

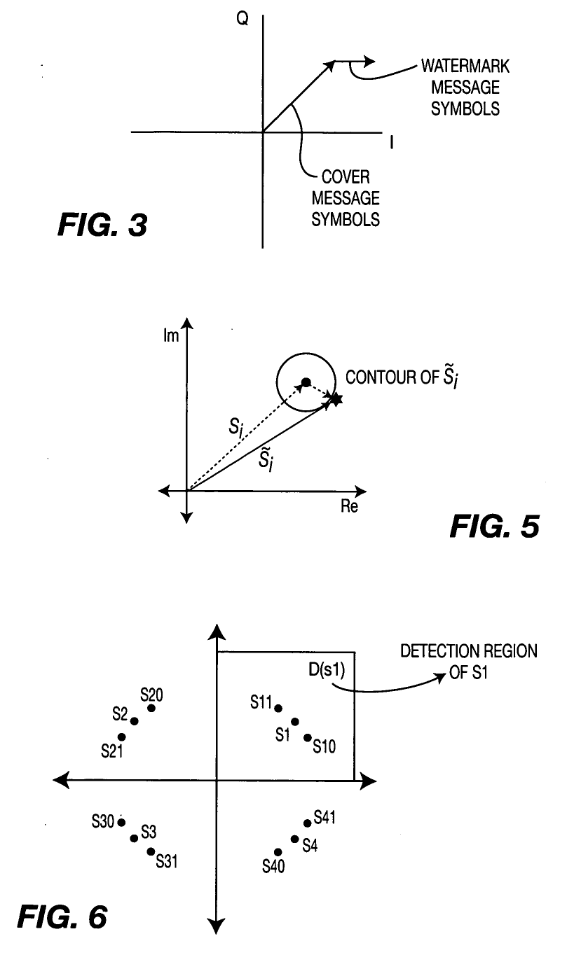

In accordance with the present invention, the watermark message 111 is directly overlaid onto the cover message 113, as shown in FIG. 3. The cover message 113 is a binary signal which is encoded as a plurality of symbols. Each of the symbols is mapped to one of constellation points by the watermark encoder 112, depending on a modulation scheme. The modulation scheme may be binary phase shift keying (BPSK), QPSK, quadrature amplitude modulation (QAM), or the like. For example, if the cover message 113 is modulated by using QPSK, every two bits of the cover message 113 is mapped to one of the four constellation points S1-S4, as shown in FIG. 4A.

The watermark message 111 is also a binary signal which is encoded as symbols by the watermark encoder 112, depending on the modulation scheme. The modulation scheme may be BPSK, QPSK, QAM, orthogonal frequency division multiplexing (OFDM), orthogonal frequency division multiple access (OFDMA), or the like. The symbols of the watermark message 111 are overlaid onto the symbols of the cover message 113, as illustrated in FIGS. 3 and 4B. For example, in FIG. 4B, both the cover message 113 and the watermark message 111 are modulated by QPSK, and after overlaying the symbols of the watermark message 111 onto the symbols of the cover message 113, the constellation points, (depicted by the four stars), fall around each of the four constellation points S1-S4 in FIG. 4B. It should be noted that the cover message 113 and the watermark message 111 may be modulated by any type of modulation schemes, as it is obvious to those skilled in the art.

In the above example, watermarking is performed at the symbol rate of the cover message 113; although this is not specifically necessary. In general, the watermark message 111 has a substantially lower amplitude than the amplitude of the cover message 113. Therefore, the watermark message symbols appear as a small perturbation around the constellation points S1-S4 of the cover message symbols, as shown in FIG. 4B.

Since the perturbations are small, an individual symbol of the watermark message 111 may span over a plurality of cover message symbols to ensure an adequate signal-to-noise ratio (SNR) at the receiver. The spanning may be performed by repetition of the watermark message symbol over several cover message symbols or prior to modulation, a coder, such as a convolutional coder, may be used to map a watermark message bit to several bits which span several cover message symbols. Alternatively, the watermark message symbols may be spread over several cover signal symbols by scrambling or spreading with a scrambling code or a spreading code over a plurality of cover signal symbols similar to code division multiple access (CDMA) signal spreading. At the receiver, a symbol derepetition or despreading is performed to despan the spanned watermark message symbol.

FIG. 5 graphically depicts a watermark-embedded cover message in accordance with the present invention. In FIG. 5, a watermark message symbol Wis added to a cover message symbol Sᵢ in the first quadrant of the QPSK constellation to generate a resultant output vector, (i.e., a watermark-embedded symbol), \tilde{S}ᵢ. In general, the resultant watermark-embedded symbol vector, \tilde{S}ᵢ, in the i-th quadrant, is written by:
\tilde{S}ᵢ=Sᵢ+W; Equation (1)
where Sᵢ is the i-th cover message symbol vector and W is the watermark message symbol vector in the QPSK constellation. The modulation scheme, (i.e., equivalent constellation points), used by the cover message symbol may be different for the watermark message symbol.

Assuming that the watermark message symbol vector W is a random vector with zero mean and variance of σ_{w}², the average SNR of the watermark-embedded message can be given by:

$$SNR = \frac{{\vert E \{ {S}_{i} + {W}_{i} \} \vert}^{2}}{{σ}_{W}^{2} + {σ}_{AWGN}^{2}} = \frac{{S}^{2}}{{σ}_{W}^{2} + {σ}_{AWGN}^{2}} ; \qquad Equation ( 2 )$$

where S is the expected value (or average) of the collective signal Si, the subscript i is an index to a set of values, σ_{w}² and σ_{AWGN}² represent variance of the watermark message and the additive white Gaussian noise (AWGN), respectively, and |E{Sᵢ+Wᵢ}|² is an average power of a sum of the watermark message symbol and the cover message symbol.

As shown in Equation (2), the average power, (or amplitude), of the cover message symbols does not change due to the dithering caused by the watermark message symbols. But the SNR for the cover message reduces due to the smearing of constellation points caused by the watermark message.

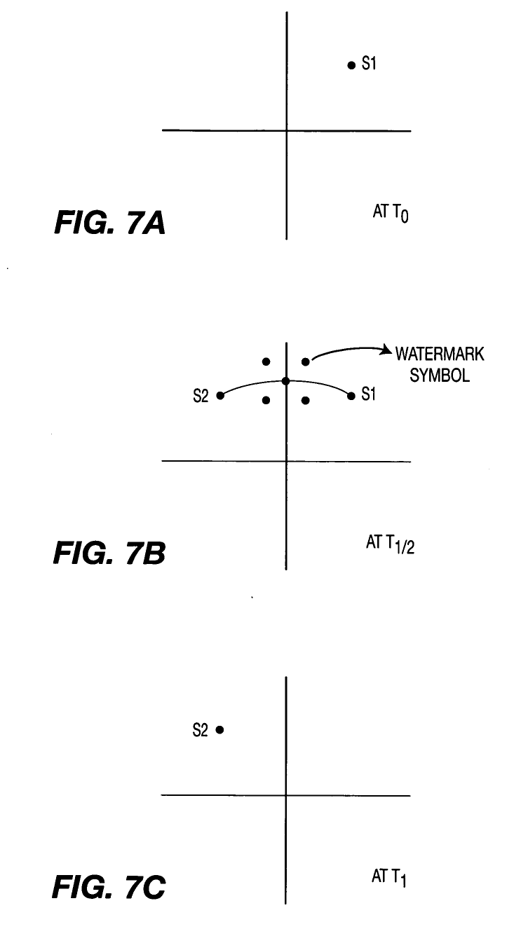

Alternatively, the cover message symbol and the watermark message symbol may be combined after transmit filtering and the symbol timing phase for the cover message symbol may be varied relative to the watermark message symbol. For example, a misalignment of the signals by half a symbol time would align the center of the cover message symbol with the edge of a watermark message symbol. FIGS. 7A-7C show constellation points of cover message symbols and a watermark embedded cover message symbol with a timing offset in accordance with the present invention. Assume that a cover message symbol at T₀ is S1 as shown in FIG. 7A and a cover message symbol at T₁ is S2 as shown in FIG. 7C. By misaligning the signals half a symbol time, the watermark message symbol would be overlaid in the middle of transition from S1 to S2 at time T_{1/2} as shown in FIG. 7B.

Referring again to FIG. 1, receive processing of the watermark-embedded signal will now be described hereinafter. The receiver 120 includes a receive processor 122, a cover message decoder 124 and a watermark decoder 126. A transmitted watermark-embedded signal 121 is received over the channel 118 of the air interface by the receiver 120 and processed by the receive processor 122. A signal 123 generated by the receive processor 122 is fed to both the cover message decoder 124 and the watermark decoder 126. The cover message decoder 124 generates estimated cover message symbols 125 from the processed signal 123. The cover message symbols 125 are first estimated and the estimated cover message symbols 125 are then fed to the watermark decoder 126 to aid in watermark symbol detection. The watermark decoder 126 then recovers the watermark message 111 after subtracting the estimated cover message symbols 125 from the processed signal 123.

The pseudo-random pattern of the watermark signal is camouflaged as small noise-like perturbations riding over the cover signal constellation points. The symbol decisions made by the cover message decoder 124 on the cover message enable the recovery of the constellation points of the watermark message 111. When the watermark message 111 is optionally encrypted with a secret key 114 by the watermark encoder 112, the recovered watermark message is decrypted with a secret key 128 by the watermark decoder 126.

FIG. 6 shows the symbol constellation of the watermark-embedded signal. For illustration, it is assumed in FIG. 6 that the modulation scheme for the cover message signal is QPSK and the modulation scheme for the watermark bits is BPSK, so that the size of the constellation is 8. The symbol Sij denotes that a cover message symbol is S1 and a watermark bit is j. For example, the symbol S10 denotes that a cover message symbol is S1 and a watermark bit is 0 and the symbol S11 denotes that a cover message symbol is S1 and a watermark bit is 1. By way of illustration, the detection region for cover message symbol S1 is shown as D(S1) in FIG. 6. The embedding of the watermark bits, in general, degrades the performance of the detection of the cover message symbols. This is measurable as follows. For instance, denoting the real part and imaginary part of a constellation point by x and y, a symbol error rate, (i.e., probability P of symbol error), of the cover message for S1 can be derived as follows:
P{S1≠S₁^{e}|S1}=1−∫_{D(S1)}∫f(x,y) dxdy; Equation (3)
where S₁^{e} is the estimated cover message symbol at the receiver when the transmitted cover message symbol is S1, f(x,y) represents the joint probability density function of x and y of the received signal 123 (in FIG. 1), and D(S₁) represents a detection region for S₁. The left side of Equation (3) is the probability that the estimated cover message symbol is not equal to the transmitted cover message symbol, and hence an error event. The integral on the right side of the Equation (3) is the total probability that the estimated cover message symbol equals the transmitted symbol. Consequently, 1 minus the integral is the probability of symbol error. The performance degradation measure of the detection of the cover message symbol due to the dithering caused by the watermark message symbols can be represented with an implementation loss as indicated by the difference in curves for symbol error rate vs. SNR with watermarking and without watermarking.

Conventional techniques, such as transmission of training sequence, channel coding/decoding, interleaving/deinterleaving, rate matching, spreading/despreading, encryption/decryption, or the like may be implemented by the transmitter 110 and the receiver 120 to the watermark message 111 to provide immunity to an effect by the communication channel and various forms of attack and protection from eavesdroppers.

The scheme of the present invention may also be applied to an OFDM system. Modulated symbols on the sub-carriers may be perturbed by a watermark message 111 in a similar manner by overlaying watermark message symbols onto the modulated symbols (i.e., cover message symbols). The watermark message symbols may span several cover message symbols to provide an adequate SNR at the receiver by repetition or channel coding. Alternatively, a watermark message 111 may be spread over several cover message symbols by scrambling or spreading with a scrambling code or a spreading code over a plurality of cover message symbols.

The watermarking scheme of the present invention may be used for receiver performance improvement, communication system improvement or security enhancement purposes. Improved receiver performance may be achieved by encoding additional information as the watermark message 111 such that the additional information enables a receiver to operate at a lower SNR to achieve the same performance or to use the additional information to achieve better performance for the same SNR. For example, the watermark message 111 may be additional parity bits from a channel encoder, channel state information to aid an equalizer in the receiver, or timing information to enable coherent reception in the receiver. In addition, the communication system performance may be improved by transmitting additional information like side or control information through the watermark channel. For example, in multimedia broadcasting, the watermark message may be used as side information such as a public notice which rides over the broadcast service as the cover message.

Security enhancement may be achieved by introducing known data as the watermark message, the encoding of which is known only by the transmitter and receiver such that the apparent SNR perceived by a receiver with and without knowledge of the watermark channel can be altered to degrade performance for the receiver oblivious to the watermark data. For example, the watermarking may be dithering introduced to create an apparent perception of additional noise on the transmitted waveform. Only a receiver which knows the watermarking information would be able to cancel the apparent noise created by the watermarking.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A method for securing wireless communications, the method comprising:
encoding a cover message using a first modulation scheme to generate cover message symbols;
encoding a watermark message using a second modulation scheme to generate watermark message symbols;
overlaying the watermark message symbols onto the cover message symbols to generate a watermark-embedded cover message; and
transmitting the watermark-embedded cover message over a channel of an air interface.

2. The method of claim 1 wherein the encoding and overlaying steps are selectively implemented.

3. The method of claim 1 wherein the watermark message symbols have substantially lower amplitude than the cover message symbols.

4. The method of claim 1 wherein the watermark message is embedded onto the cover message at a symbol rate of the cover message.

5. The method of claim 1 wherein at least one of the watermark message symbol spans over a plurality of cover message symbols.

6. The method of claim 5 wherein the watermark message symbol spans over the several cover message symbols by performing a channel encoding on the watermark message symbols.

7. The method of claim 1 wherein a watermark message symbol is spread by a spreading code over a plurality of cover message symbols.

8. The method of claim 1 further comprising encrypting the watermark message with a secret key.

9. The method of claim 1 wherein the method is implemented in an orthogonal frequency division multiplexing (OFDM) system.

10. The method of claim 1 wherein additional information is encoded as the watermark message, whereby performance of the wireless communications is improved by the additional information.

11. The method of claim 10 wherein the watermark message includes additional parity bits generated by a channel coder used in encoding the cover message.

12. The method of claim 10 wherein the watermark message includes channel state information to be used by an equalizer or other form of detector in a receiver.

13. The method of claim 10 wherein the watermark message includes side information to be used to improve communication system services.

14. The method of claim 10 wherein the watermark message includes timing information used to enable coherent reception in a receiver.

15. The method of claim 1 wherein the watermark message is data known to both a transmitter and a receiver, whereby an apparent received signal-to-noise ratio (SNR) for the receiver is degraded and security is enhanced by the embedded watermark message.

16. The method of claim 1 wherein the first modulation scheme and the second modulation scheme are different.

17. The method of claim 1 further comprising:
receiving the watermark-embedded cover message;
processing the watermark-embedded cover message to generate an estimated cover message; and
processing the watermark-embedded cover message to generate an estimated watermark message based on the estimated cover message.

18. The method of claim 17 further comprising decrypting the estimated watermark message with a secret key.

19. The method of claim 1 wherein the modulation scheme is one of a binary phase shift keying (BPSK), quadrature phase shift keying (QPSK), quadrature amplitude modulation (QAM), orthogonal frequency division multiplexing (OFDM) and orthogonal frequency division multiple access (OFDMA).

20. The method of claim 1 further comprising:
rotating a constellation point of the watermark message symbol by a fixed angle prior to embedding the watermark message symbol onto the cover message symbol.

21. The method of claim 1 wherein the cover message symbol and the watermark message symbol are combined after transmit filtering such that a symbol timing phase for the cover message symbol is varied relative to the watermark message symbol.

22. A transmitter for securing wireless communications, the transmitter comprising:
a watermark encoder configured to encode a cover message using a first modulation scheme to generate encoded cover message symbols, to encode a watermark message using a second modulation scheme to generate watermark message symbols, and to overlay the watermark message symbols onto the cover message symbols to generate a watermark-embedded cover message; and
a transmit processor configured to transmit the watermark-embedded cover message over a channel of an air interface.

23. The transmitter of claim 22 wherein the watermark encoder is selectively turned on and off.

24. The transmitter of claim 22 wherein the watermark encoder is configured to embed the watermark message symbols having substantially lower amplitude than the cover message symbols.

25. The transmitter of claim 22 wherein the watermark encoder is configured to embed the watermark message onto the cover message at a symbol rate of the cover message.

26. The transmitter of claim 22 wherein the watermark encoder is configured to span a watermark message symbol over a plurality of cover message symbols.

27. The transmitter of claim 26 wherein the watermark encoder is configured to span the watermark message symbol by repeating the watermark message symbol.

28. The transmitter of claim 26 wherein the watermark encoder is configured to span the watermark message symbol over several cover message symbols by performing a channel encoding on the watermark message symbols.

29. The method of claim 22 wherein the first modulation scheme and the second modulation scheme are different.

30. The transmitter of claim 22 wherein the watermark encoder is configured to spread a watermark message symbol with a spreading code over a plurality of cover message symbols.

31. The transmitter of claim 22 wherein the watermark encoder is configured to encrypt the watermark message with a secret key.

32. The transmitter of claim 22 wherein the transmitter comprises an orthogonal frequency division multiplexing (OFDM) system.

33. The transmitter of claim 22 wherein the watermark encoder is configured to encode additional information as the watermark message, whereby performance of the wireless communication system is improved by the additional information.

34. The transmitter of claim 33 wherein the watermark message includes additional parity bits generated by channel coding.

35. The transmitter of claim 33 wherein the watermark message includes channel state information to be used by a receiver.

36. The transmitter of claim 33 wherein the watermark message includes side information to be used to improve communication system services.

37. The transmitter of claim 33 wherein the watermark message includes timing information used to enable coherent reception.

38. The transmitter of claim 22 wherein the watermark message is data known to both the transmitter and a receiver, whereby an apparent received signal-to-noise ratio (SNR) for the receiver is degraded and security is enhanced by the embedded watermark.

39. The transmitter of claim 22 wherein the modulation scheme is one of a binary phase shift keying (BPSK), quadrature phase shift keying (QPSK), quadrature amplitude modulation (QAM), orthogonal frequency division multiplexing (OFDM) and orthogonal frequency division multiple access (OFDMA).

40. The transmitter of claim 22 wherein the transmitter is configured to combine the cover message symbol and the watermark message symbol after transmit filtering such that a symbol timing phase for the cover message symbol is varied relative to the watermark message symbol.

41. The transmitter of claim 22 wherein the watermark encoder comprises:
a cover message encoder for encoding the cover message to generate an encoded cover message;
a symbol mapping unit for mapping the encoded cover message to a cover message symbol;
a watermark encoder for encoding the watermark message to generate an encoded watermark message symbol; and
a watermark symbol mapping and embedding unit for mapping and embedding the encoded watermark message symbol onto the cover message symbol.

42. The transmitter of claim 41 wherein the watermark symbol mapping and embedding unit rotates the encoded watermark symbol by a fixed angle prior to embedding the encoded watermark symbol onto the cover message symbol.

43. The transmitter of claim 41 wherein the watermark encoder and the watermark symbol mapping and embedding unit are selectively turned on and off.

44. A receiver for securing wireless communications, the receiver comprising:
a receive processor for processing a watermark-embedded signal;
a cover message decoder for processing an output generated by the receive processor to generate an estimated cover message; and
a watermark decoder for processing the output generated by the receive processor to generate an estimated watermark message based on the estimated cover message.

45. The receiver of claim 44 wherein the watermark decoder is configured to decrypt the estimated watermark message with a secret key.

46. The receiver of claim 44 wherein the watermark decoder is configured to despan watermark message symbols spanned over a plurality of cover message symbols.

47. The receiver of claim 46 wherein the watermark decoder is configured to perform a derepetition of watermark message symbols spanned over a plurality of cover message symbols.

48. The receiver of claim 44 wherein the watermark decoder is configured to despan watermark message symbols by performing a channel decoding on the watermark message symbols.

49. The receiver of claim 44 wherein the watermark decoder is configured to despread a watermark message symbol with a spreading code over a plurality of cover message symbols.

50. The receiver of claim 44 wherein the receiver comprises an orthogonal frequency division multiplexing (OFDM) system.

51. The receiver of claim 44 wherein the watermark decoder is configured to decode additional information embedded as the watermark message, whereby performance of the wireless communication system is improved by the additional information.

52. The receiver of claim 51 wherein the watermark decoder is configured to recover additional parity bits embedded as the watermark message.

53. The receiver of claim 51 wherein the watermark message includes channel state information to be used by the receiver.

54. The receiver of claim 51 wherein the watermark message includes side information to be used to improve communication system services.

55. The receiver of claim 51 wherein the watermark message includes timing information used to enable coherent reception.
